(19) United States
(12) Patent Application Publication
(10) Pub. No.: US 2025/0307221 A1
(43) Pub. Date: Oct. 2, 2025

(54) LARGE DATA TRANSFER AMONG DATABASE SERVERS

(71) Applicant: Oracle International Corporation, Redwood Shores, CA (US)

(72) Inventors: Sunitha Subramanyam, Redwood City, CA (US); Zhen Hua Liu, San Mateo, CA (US); Jose Omar Alvizo Flores, Foster City, CA (US)

(21) Appl. No.: 19/076,392

(22) Filed: Mar. 11, 2025

Related U.S. Application Data
(60) Provisional application No. 63/573,136, filed on Apr. 2, 2024.

(51) Int. Cl. G06F 16/22; G06F 16/2455; G06F 16/27

(52) U.S. Cl. CPC G06F 16/2219; G06F 16/24568; G06F 16/27

(57) ABSTRACT

Techniques are described for efficient transfer of large data type data (large data) among database servers for executing a distributed query. In an implementation, a database server receives object reference data, including an indication of whether the object reference data is a quasi-locator. The receipt of the quasi-locator indicates that the large data is to be streamed from the large database repository without any further request from the receiving database server. Accordingly, the receiving database server receives and stores the requested large data without generating and sending any further requests to the large data repository database server.

### BENEFIT CLAIM

This application claims the benefit under 35 U.S.C. § 119(c) of provisional application 63/573,136, filed Apr. 2, 2024, the entire contents of which is hereby incorporated by reference for all purposes as if fully set forth herein.

### FIELD OF THE TECHNOLOGY

The present invention relates to the field of electronic database management, in particular to large data transfer among database servers.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

A database management system (DBMS) may include multiple database servers that may provide redundancy, load balancing, and/or distribute data logically across the database servers. Such a DBMS is referred to as a distributed database management system (DDBMS), and each database server may be referred to as a “shard”.

When a query is received by one of the database servers of DDBMS, the query may reference multiple database instances that are managed by different database servers. Accordingly, when the one database server executes the received query, the database server may request remote data from another database server or an execution of at least a portion of the query on the remote data of the different database server.

Such remote data may be a column of large object data (LOB). An LOB column may store a semi-structured data document in each row, such as an extensible Markup Language (XML) document or a Javascript Object Notation (JSON) document.

Because LOB columns and the tables that contain them are voluminous and, thus, resource-heavy for query operations, the retrieval of LOB column data occurs in two roundtrips. In the first roundtrip, the requesting entity, such as the client system or a coordinator database server, receives the object reference data that references the location of the LOB data, the LOB locator. The LOB locators may be database-specific physical addresses for accessing LOB data and may additionally include the generation timestamp on the originating database or other metadata. For example, an LOB locator may contain the LOB Identifier, LOB version, and the SCN (database logical timestamp) of the LOB generation.

In the first roundtrip, the requester of the LOB data may cache the LOB locator for the requested LOB data. In the second roundtrip, the client system may request at least a portion of the LOB data to be fetched using the LOB locator. The two roundtrips may repeated until the complete LOB data is fetched.

The advantage of the two roundtrips approach is that the client/requester may maintain the LOB locator and be able to fetch or update the LOB data on subsequent requests. Thus, if the data of the same LOB is repeatedly requested or updated, then this two-round trip approach saves significant processing time by proceeding directly to fetching LOB data in subsequent requests.

However, this approach introduces significant inefficiency when different LOBs are requested across many database servers. For example, the DDBMS may have 100's of shard database servers that partition logs stored in JSON, each database server storing a particular time period of logs in an LOB column. In such a scenario, executing a query that aggregates the logs incurs the cost of hundreds of additional roundtrips and introduces significant computational costs. Especially when database servers are located in different regions, the network latency may be significant, and each extra roundtrip may be very costly.

The problem is further exacerbated by “CREATE TABLE AS SELECT” (CTAS) or “INSERT TABLE AS SELECT” (ITAS) query constructs, in which temporary LOB data may be referenced. These constructs create local temporary tables that may include LOB columns from remote database servers. Even though CTAS and ITAS may specify criteria that may significantly reduce the amount of LOB data that needs to be fetched into the temporary tables, the querying database server has no choice but to perform the two roundtrip technique and, in the second roundtrip to transfer the full contents into the LOB column for applying the criteria on the querying database server. Such an approach further burdens the network and introduces significant latency in executing distributed queries with CTAS and ITAS constructs.

### BRIEF DESCRIPTION OF THE DRAWINGS

In the drawings of certain implementations in which like reference numerals refer to corresponding parts throughout the figures:

FIG. 1 is a block diagram that depicts a Distributed Database Management System (DDBMS), in one or more implementations;

FIG. 2 is a sequence diagram depicting the process for performing large data transfer from a Large Data Repository Database Server (LDBS) to a receiving database server to execute a client query, in one or more implementations;

FIG. 3 is a block diagram that depicts the process for determining the type of transfer for large data from an LDBS, in an implementation.;

FIG. 4 is a block diagram that depicts the process for receiving, processing and storing streamed large data from a remote LDBS, in one or more implementations;

FIG. 5 is a sequence diagram that depicts the transferring of large data to a remote database server for remote processing, in one or more implementations;

FIG. 6 is a block diagram of a basic software system, in one or more implementations;

FIG. 7 is a block diagram that illustrates a computer system upon which an implementation of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, structures and devices are shown in block diagram form in order to avoid unnecessarily obscuring the present invention.

### General Overview

Techniques for transferring large data type data (large data) among database servers are described herein. Large data refers to unstructured or semi-structured data, such as text, images, videos, and documents, which may be too large to be stored in the arranged manner in memory (e.g., columnar/column-major or row store/row-major) and, thus, is accessed through the respective object reference data indicating the memory location of the storage. In an implementation, the object reference data (also referred to herein as “locator”) is extended to include an indication of whether the requested large data, such as LOB, is going to be streamed over a network without receiving additional request(s) for the large data. Rather than requiring the two-roundtrip approach, the large data may be streamed from the large data repository database server (LDBS) in response to the initial request for transfer of the large data. The requesting database server may not need to send the received object reference data to fetch at least a portion of the requested large data from the LDBS.

The extended object reference data is referred to herein as “quasi-locator.” The term “large data repository database server” (LDBS) refers to a database server in a DDBMS that stores the requested large data. The database server that requests the large data from the LDBS or is sent the large data from the LDBS in the DDBMS is referred to as the “receiving database server”. Non-limiting examples of receiving database servers may be a local database server or a coordinator database server that receives the query execution request from a client system and requests the large data from another database server, an LDBS, for the execution of the query.

A receiving database server of a DDBMS may generate and select an execution plan for a received query that specifies data operation on large data stored on a remote LDBS of the DDBMS. Such an operation may be a temporary table definition statement with CTAS or IAS construct referencing an LOB column of the LDBS. In this example, the execution of the query on the receiving database server includes a request to the LDBS to transmit the large data to the receiving database server for execution.

To provide the requested large data, in response to receiving the request from the receiving database server, the LDBS may generate a quasi-locator. The quasi-locator includes an indication of whether the quasi-locator indeed references the requested large data (and has to be resent to fetch at least a portion of the large data) or whether the requested data is to be streamed without any additional request. For example, the received LOB quasi-locator may include a bit, which, when set, would indicate that LOB data is being automatically streamed from the LDBS without additional receipt of the LOB locator to fetch the LOB data or a portion thereof.

In an implementation, after or in parallel with sending the object data reference, but without receiving any additional request for the large data, the LDBS automatically initiates the transfer (sending) of the large data to the receiving database server. The LDBS may stream the large data to the receiving database server, which may store the large data in temporary storage. Based on comparing the size of the large data to the buffer threshold, the receiving database server determines whether to store the large data in the fast-accessible buffer memory or slow-accessible disk storage memory.

### System Overview

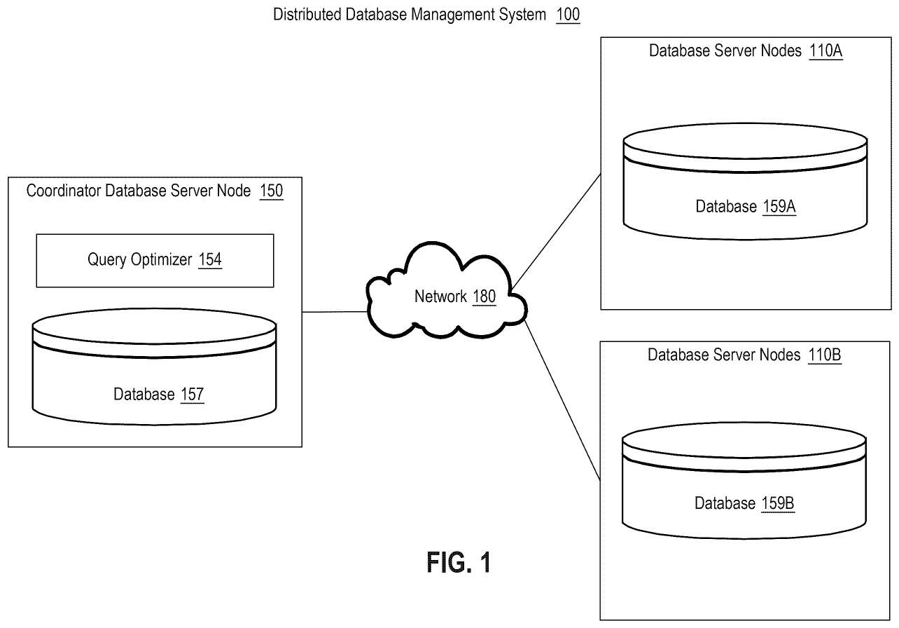

FIG. 1 is a block diagram that depicts a distributed database management system (DDBMS) 100, in an implementation. Although the techniques described herein are applicable to any type of DBMS, the techniques are particularly beneficial to distributed database management systems. Distributed database management systems, such as DDBMS 100, have multiple nodes interconnected by a network, such as Network 180. Accordingly, to execute operations, data is constantly shuffled around the nodes through Network 180, which makes the size of data and number of interactions critical to reducing network latency. The techniques described herein improve the efficiency of the query execution in a distributed data environment by reducing the latency of large data transfer over the network.

In an implementation, DDBMS 100 includes one or more database servers, such as Coordinator Database Server Node 150, Database Server Node 110A, and Database Server Node 110B. Each of these database server nodes may collectively or individually be a separate database management system described in more detail in the “Database Management Systems” section. The cluster of nodes of DDBMS 100 is further described in the “Computing Nodes and Clusters” section. Although only three nodes, 150, 110A and 110B, are depicted, other implementations may include more or less than two shards.

### Query Execution

A client system (not depicted in FIG. 1) may issue a database query execution request to DDBMS 100. In response to the request, DDBMS 100 executes the query and returns the result to the client system. In an implementation, Coordinator Database Server Node 150 of DDBMS 100 receives the query request stores and serves up the response to the client system from DDBMS 100. To execute the query, Coordinator 150 may first convert the query into an execution plan. As used herein, an “execution plan” is an ordered set of operators used to access data in a database management system. Each operator may contain one or more data operations on the output data of another operator or on database objects. Query Optimizer 154 receives a query as an input and generates an execution plan for the query, in an implementation. Query Optimizer 154 may include a plan generator that generates one or more alternative execution plans for the query. The plan generator may generate those plans based on an analysis of access paths for database objects, operations described in the query, and/or pre-execution statistics thereof.

Based on the analysis, the plan generator may produce a permutation of execution plans, one of which may be selected based on the execution cost (e.g., computing cost). After selecting an optimal execution plan for a query, Coordinator Node 150 obtains and executes the execution plan, in an implementation.

The execution plan for a distributed query may reference CTAS/IAS/merge of LOBs operations and/or the operations involving temporary LOBs, JSON/XML datatype LOB columns, and value-based LOBs that are stored on Databases 159A and/or 159B. Those database instances are serviced by different database server nodes (shards), such as Database Server Node 110A and Database Server Node 110B, respectively. Each of their respective Databases 159A/B may store different logical portions of large data, or different large data all together. Accordingly, query optimizer 154 may generate an execution plan that may include querying different (portions of) large data from databases 159A/B and Coordinator 150's database 157.

To execute such an execution plan by Coordinator Database Server Node 150, Coordinator 150 may request Database Server Node 110A and/or Database Server Node 110B to transfer the requisite large data from respective Database 159A and Database 159B to Coordinator Database Server Node 150. Only after the transfer of such large data from the remote database server(s) can the optimal execution plan be performed on Coordinator Database Server Node 150.

### Initiating Large Data Transfer

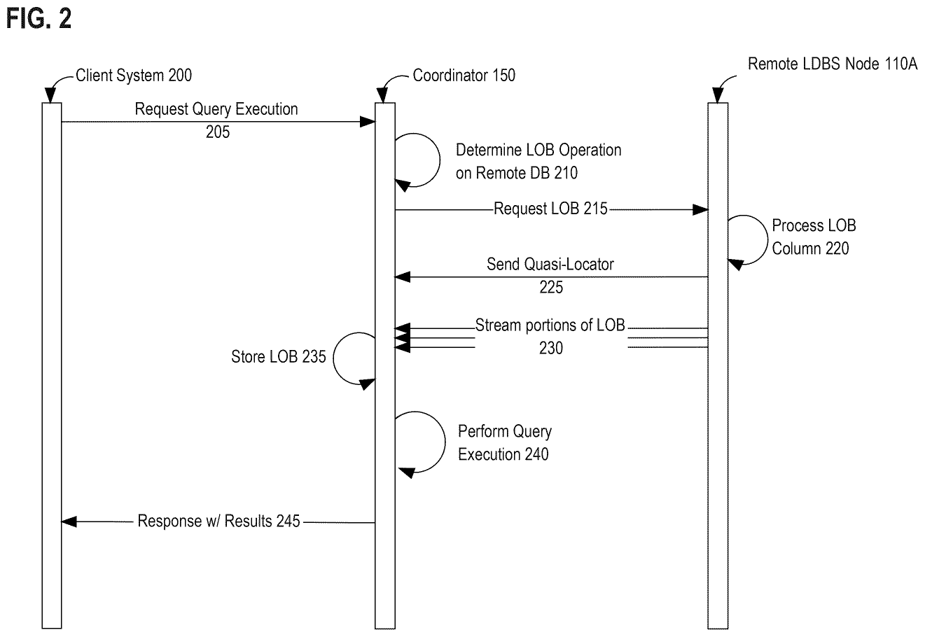

Techniques described herein include the efficient transfer of large data between database servers of DDBMS 100 for query execution. FIG. 2 is a sequence diagram depicting the process for performing large data transfer from an LDBS to a receiving database server to execute a client query, in one or more implementations.

Coordinator 150, as a receiving database server, receives a query execution request from Client System 200 at step 205, in an implementation. At step 210, Coordinator 150 determines that for the query execution, an operation is to be performed on large data stored on Remote LDBS Node 110A. For example, the received query may include a DEFINE with a CTAS/ITAS operator referencing an LOB column stored on Remote LDBS Node 110A. Thus, the generated optimal execution plan by Coordinator 150 includes an operation on the LOB column stored on Remote LDBS Node 110A.

At step 215, Coordinator 150 may send a request to Remote LDBS Node 110A to retrieve the LOB column requested for the query execution. This request for the large data from Coordinator 150 may indicate to Remote LDBS 110A the support for the automatic streaming of large data by including the indication of the capability for receiving a stream of the large data. Upon the receipt of the request for large data, such as an LOB column, from Coordinator 150 at step 215, Remote LDBS Node 110A, at step 220, retrieves the LOB column from Database 159A to send to Coordinator 150.

In an implementation, the request from Coordinator 150 additionally contains the operation to be performed on the large data (e.g., scan with a predicate) based on the execution plan. If Coordinator 150, rather than Remote LDBS 110A, performs the operation, then Coordinator 150 has to wait until the large data is completely transferred from Remote LDBS Node 110A. Instead, since the operation is part of the request to Remote LDBS Node 110A, Remote LDBS Node 110A may locally perform the operation on the large data. Since the operation may reduce the size of the resulting large data, such a technique decreases the amount of large data transferred and, thus, further improves the efficiency and the latency of the query execution on Coordinator 150.

For example, at step 215, Remote LDBS Node 110A may receive a request for an LOB column of Database 159A that further includes a request for a scan operation with a predicate operation to be performed thereon. Remote Node 110 may execute the predicate on the LOB column and then send only the resulting sub-set of large data of the LOB column, resulting in quicker data transfer to Coordinator 150 and, thus, reduced latency in the query execution.

### Types of Large Data Transfer

In an implementation, the received request at the LDBS, such as the request received at step 215, may also indicate the type of large data transfer supported by the receiving database server. The LDBS may use the more efficient automatic streaming type data transfer or the two-round trip request-based data transfer. In an implementation, if the LDBS and the receiving database server support the automatic streaming type data transfer, then the LDBS may automatically perform the efficient streaming of large data to the receiving database server without any additional request (object reference data containing request) from the receiving database server.

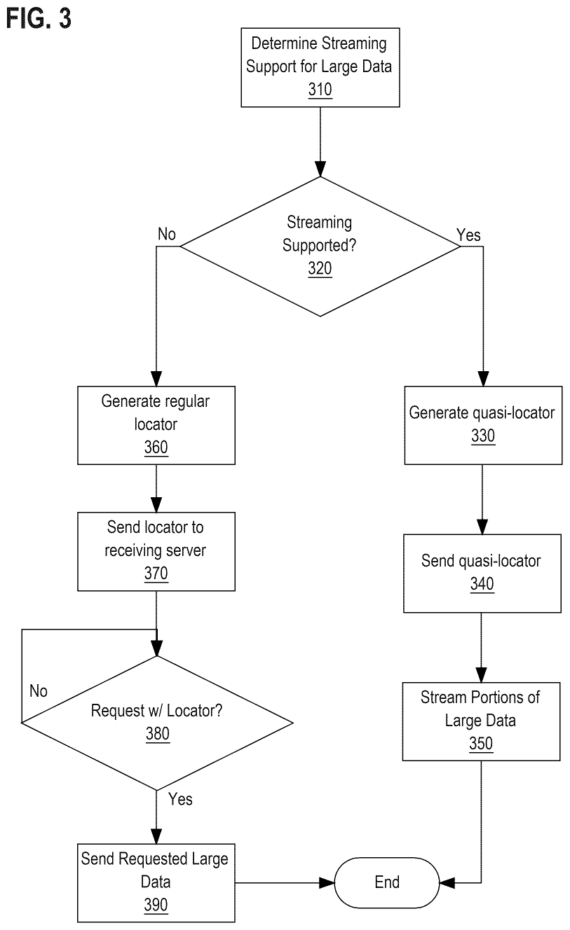

FIG. 3 is a block diagram that depicts the process for determining the type of transfer for large data from an LDBS, in an implementation. At step 310, the LDBS determines whether the receiving database server supports the automatic streaming of large data. The request received by the LDBS may contain an indication of such support by the receiving database server. For example, the request received for LOB column operation on Remote LDBS Node 110A may contain an indication of support for the automatic streaming of LOB data. Remote Node 110 may examine this indication and determine the existence of such support by Coordinator 150 at step 320.

If, at step 320, the process determines that there is support for the automatic streaming of large data, the process proceeds to step 330. Otherwise, the process proceeds to step 360 to generate a regular locator. At step 370, the process sends the locator to the receiving database server for the receiving database server to use the locator when fetching the large data of the LDBS. At step 380, the LDBS has to wait to receive a request for the large data (or a portion thereof) that includes the previously sent locator. Upon the receipt of such a request at step 380, the LDBS retrieves the large data from the storage and sends to the receiving database server at step 390. The wait, receipt, and sending cycle of steps 380 and 390 may have to be repeated for each portion of the large data until the large data is completely sent.

### Quasi-Locator

Unlike regular locator request-based transfer of large data, if it is determined that the automatic streaming is supported by the receiving database server at step 320, at step 330, a quasi-locator is generated. In an implementation, in addition to indication about the support for automatic streaming of large data, the quasi-locator contains metadata about the large data, such as the size, data type (JSON, XML) and/or character set of the large data. The indication for streaming and metadata may be sent together or separately to the receiving database server at step 340.

At step 350, without any request from the receiving database server to initiate the transfer of the large data (or a portion thereof), the LDBS initiates the streaming of portions until all portions are sent to the receiving database server. For example, continuing with FIG. 2, at step 225, Remote LDBS Node 110A may generate a quasi-locator for the requested LOB data by Coordinator 150. In addition to the indication that Remote LDBS Node 110A supports automatic streaming, the generated quasi-locator may include metadata about the large data, such as the size of the resulting LOB data, the LOB column type, and the character set (encoding) of the content of the LOB data. If the LOB column contains semi-structured JSON or XML data, the data type may be indicated along with the character set (ANSI, UTF-8, UTF-16). That way, the receiving database, Coordinator 150, may be able to seamlessly integrate the received LOB data into its query processing for efficiently performing the query for Client System 200.

After sending the quasi-locator with metadata about the LOB column at step 225 to Coordinator 150 and without receiving from Coordinator 150 any further request for the LOB data, Remote LDBS Node 110A initiates the streaming of the LOB data to Coordinator 150 by sending portion(s) of the requested LOB data to Coordinator 150, at step 230.

### Receiving Large Data Transfer

Coordinator 150 receives the quasi-locator at step 225. Based on the quasi-locator, Coordinator 150 receives, processes and stores the streamed portions of the LOB column until the complete large data is transferred from Remote LDBS Node 110A to Coordinator 150.

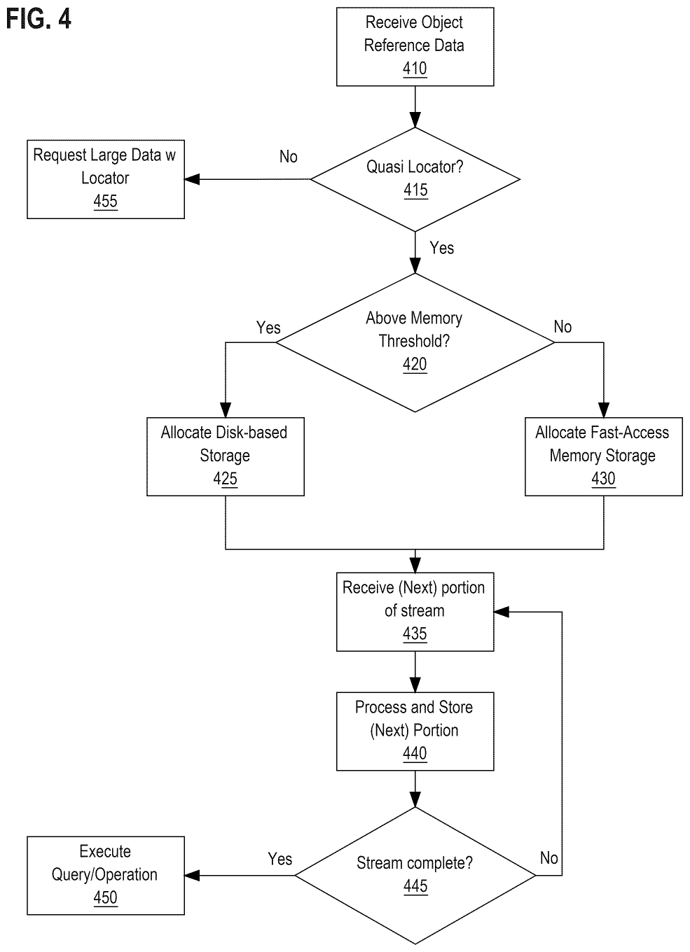

FIG. 4 is a block diagram that depicts the process for receiving, processing and storing streamed large data from a remote LDBS, in one or more implementations. At step 410, the receiving database server receives a locator in response to the request for large data stored on the remote LDBS.

At step 415, the receiving database server determines whether the received object reference data is a quasi-locator for streaming the requested large data or a regular locator for future fetching of portions of the requested large data. The indication included in the received object reference data may indicate the type of locator and, thus, the type of transfer to be performed by the LDBS. Such an indication may be a bit set/unset, respectively, within the object reference data by the LDBS. Additionally or alternatively, the non-existence of the indication in the object reference data may also be an indication of the locator being a regular locator.

If, at step 415, the receiving database server determines, based on the indication or the lack thereof, that the received object reference data is a regular locator, then the process transitions to step 455, and the receiving server sends a separate additional request with the locator to fetch the large data (or portions thereof) from the LDBS.

Otherwise, if, at step 415, it is determined that the received object reference data contains an indication that the LDBS supports automatic streaming of the requested large data to the receiving database server, then the process determines that the object reference data is a quasi-locator. The process transitions to step 420 to process the streamed (portions of) large data.

Additionally, the quasi-locator may contain metadata about the size of the large data being streamed. In such an implementation, at step 420, the process determines whether the size of the large data, as indicated in the quasi-locator, is above or below a memory threshold. If the size is above the memory threshold (e.g., greater or equal), then the process allocates memory space for large data in a slower, disk-based storage of the receiving database server at step 425. Otherwise, the process allocates the memory space in a fast-access buffer storage of the receiving database server at step 430. The memory threshold may be selected based on the availability of fast-access memory storage and/or pre-defined (e.g., by user input).

As each portion of the large data is received from the LDBS at step 435, the portion is processed and stored in the allocated memory at step 440 until all the portions of the stream are received at step 445, and thereby, the large data is fully streamed to the receiving database server.

### Processing Streamed Large Data

In an implementation, the large data may be processed by the receiving server before or after portion(s) of the large data is stored. Since the quasi-locator may contain metadata about the large data, the receiving database server may determine, based on the metadata, that additional processing is necessary for the client query execution.

In an implementation, the quasi-locator may include information on the character set encoding of the streamed large data. Accordingly, at step 440 or after step 445, when the receiving database server receives the large data or a portion thereof, the receiving database server may convert the large data from the current character set/encoding indicated in the quasi- locator to the desired character set/encoding for the query operation.

Once the large data is efficiently streamed to the receiving database server, the query requested by the client may be executed according to the execution plan at step 450. The stored large data may be cast into an appropriate type of temporary data structure of the receiving database server according to the execution plan of the client query.

For example, continuing with FIG. 2, at step 235, Coordinator 150 completes storing the received large data of the LOB column in the local storage and propagates the stored data as temporary LOB column data for the query execution. Having access to the received data, Coordinator 150 may execute the operation of the execution plan of the query that references the temporary LOB column at step 240. At step 245, Coordinator 150 returns the result of the query execution to Client System 200. If the result of the query execution includes another LOB column, the same techniques described herein may be used to transfer the resulting LOB data to Client System 200 at step 245. For this transfer of large data to Client System 200, Client System 200 has a receiving database server role, while Coordinator 150 is an LDBS.

### Transferring Large Data for Remote Processing

Additionally, or alternatively, the coordinator database server that receives a query that references large data may be the database server that stores the large data and thus is the LDBS of the DDBMS. A query received by the LDBS may specify a predicate on its stored large data that is based on the evaluation performed on another database server of the DDBMS. The execution plan of such a query may contain a BIND operation on an LOB column stored locally with column(s) stored remotely on another shard database server. In such an example, the operation on the LOB and the LOB data itself are routed to the other database servers of the DDBMS for execution of the operation.

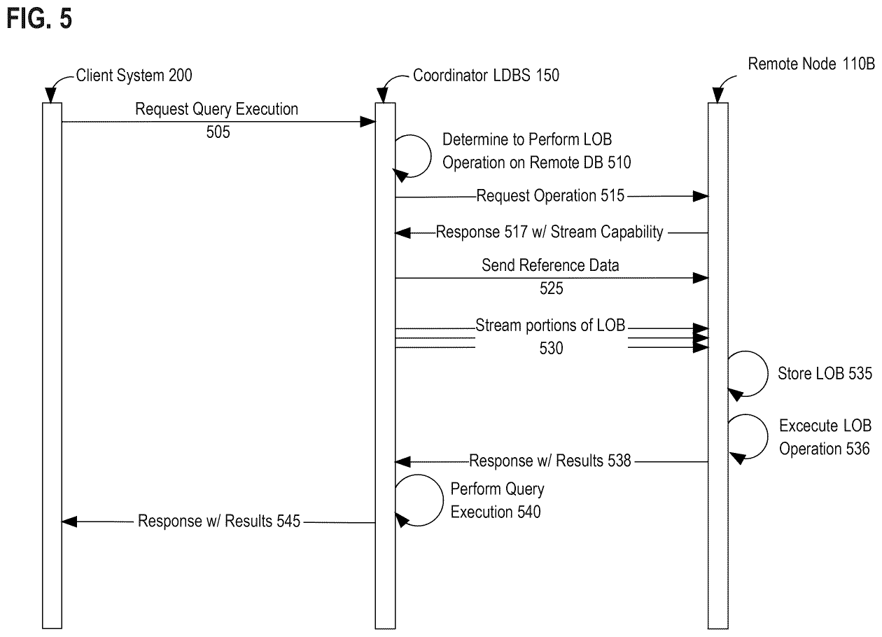

FIG. 5 is a sequence diagram that depicts the transferring of large data to a remote database server for remote processing, in one or more implementations. At step 505, Coordinator LDBS 150 receives a request for query execution from Client System 200. At step 510, Coordinator LDBS 150 may determine to perform a large data operation on Remote Node 110B by generating and selecting an execution plan with a BIND operation of a local temporary LOB of Coordinator LDBS 150 with a column on Database 159B of Remote Node 110B. At step 515, Coordinator LDBS 150 sends a request to Remote Node 110B to perform the operation on the LOB.

This request to perform the operation may include an indication of the capability of Coordinator LDBS 150 for streaming the large data without additional requests from Remote Node 110B for such large data. Upon the receipt of the request, such as an LOB column, from Coordinator LDBS 150 at step 215, Remote Node 110B, at step 517, generates a response that includes Remote Node 110B′s capability of receiving streaming portions of the large data without requests for each portion.

Similar to the techniques described above, Coordinator LDBS 150 determines the support for the streaming of the large data and generates a quasi-locator for the large data to be transferred to the receiving database server. Coordinator LDBS 150 may perform one or more steps of FIG. 3 to generate and send a quasi-locator and stream the large data itself to the receiving Remote Node 110B.

Accordingly, at step 525, Coordinator LDBS 150 generates and sends object reference data and at step 530, streams temporary LOB data to Remote Node 110B. By performing one or more steps of FIG. 4, Remote Node 110B stores the LOB data at step 535 without sending any additional request to Coordinator LDBS 150 for the LOB data and executes the operation on the received LOB data at step 536.

At step 538, the result of the execution on Remote Node 110B is sent to Coordinator LDBS 150, which may then perform the rest of the execution plan for the query and thereby execute the client request at step 540. The results of the client-requested query are then returned by DDBMS 100 to Client System 200 at step 545.

The receiving database server may store the large data in temporary memory and evaluate the query related to the large data. The receiving database server may then generate the results for the query.

### Database Management System Overview

A database management system (DBMS) manages a database. A DBMS may comprise one or more database servers. A database comprises database data and a database dictionary that are stored on a persistent memory mechanism, such as a set of hard disks. Database data may be organized into database objects and stored in one or more data containers. Each container contains records. The data within each record is organized into one or more fields. In relational DBMSs, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology to refer to database objects.

In implementations, the databases may be structured as key-value stores (e.g., NoSQL or JSON) where different database objects may represent different data structures. Key values and associated objects can be referenced, for example, by utilizing look-up tables such as hash tables.

Users interact with a database server of a DBMS by submitting to the database server commands that cause the database server to perform operations on data stored in a database. A user may be one or more applications running on a client computer that interact with a database server. Multiple users may also be referred to herein collectively as a user.

As used herein, “query” refers to a database command and may be in the form of a database statement that conforms to a database language. In one implementation, a database language for expressing the query is the Structured Query Language (SQL). There are many different versions of SQL, some versions are standard and some proprietary, and there are a variety of extensions. Data definition language (“DELL”) commands are issued to a database server to create or configure database schema, including database containers, such as tables, views, or complex data types. SQL/XML is a common extension of SQL used when manipulating XML data in an object-relational database. Although the implementations of the invention are described herein using the term “SQL,” the invention is not limited to just this particular database query language and may be used in conjunction with other database query languages and constructs.

A client may issue a series of requests, such as requests for execution of queries, to a database server by establishing a database session, referred to herein as “session.” A session comprises a particular connection established for a client to a database server, such as a database instance, through which the client may issue a series of requests. The database server may maintain session state data about the session. The session state data reflects the current state of the session and may contain the identity of the user for which the session is established, services used by the user, instances of object types, language and character set data, statistics about resource usage for the session, temporary variable values generated by processes executing software within the session, and storage for cursors and variables and other information. The session state data may also contain execution plan parameters configured for the session.

Database services are associated with sessions maintained by a DBMS with clients. Services can be defined in a data dictionary using data definition language (DELL) statements. A client request to establish a session may specify a service. Such a request is referred to herein as a request for the service. Services may also be assigned in other ways, for example, based on user authentication with a DBMS. The DBMS directs requests for a service to a database server that has been assigned to run that service. The one or more computing nodes hosting the database server are referred to as running or hosting the service. A service is assigned, at run-time, to a node in order to have the node host the service. A service may also be associated with service-level agreements, which are used to assign a number of nodes to services and allocate resources within nodes for those services. A DBMS may migrate or move a service from one database server to another database server that may run on a different one or more computing nodes. The DBMS may do so by assigning the service to be run on the other database server. The DBMS may also redirect requests for the service to the other database server after the assignment. In an implementation, after successfully migrating the service to the other database server, the DBMS may halt the service running in the original database server.

A multi-node database management system is made up of interconnected nodes that share access to the same database. Typically, the nodes are interconnected via a network and share access, in varying degrees, to shared storage, e.g., shared access to a set of disk drives and data blocks stored thereon. The nodes in a multi-node database system may be in the form of a group of computers (e.g., workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system may be allocated to running a particular database server's software. Each combination of the software and allocation of resources from a node is a server that is referred to herein as a “server instance” or “instance.” A database server may comprise multiple database instances, some or all of which are running on separate computers, including separate server blades.

### Software Overview

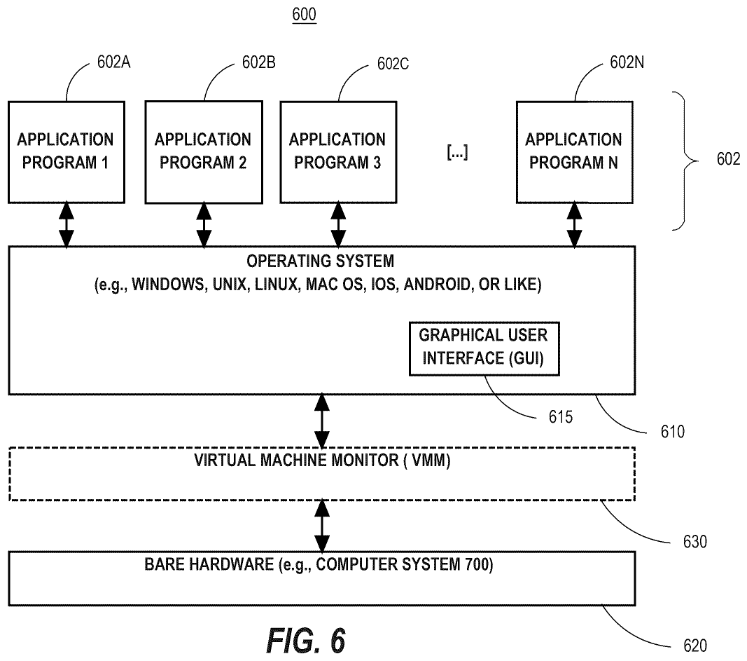

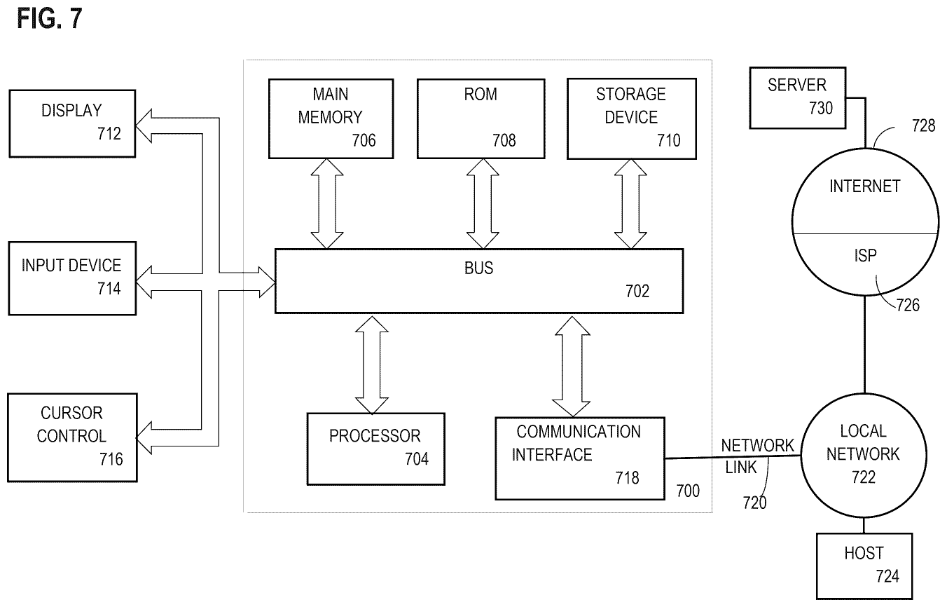

FIG. 6 is a block diagram of a basic software system 600 that may be employed for controlling the operation of computing system 700 of FIG. 7. Software system 600 and its components, including their connections, relationships, and functions, are meant to be exemplary only, and not meant to limit implementations of the example implementation(s). Other software systems suitable for implementing the example implementation(s) may have different components, including components with different connections, relationships, and functions.

Software system 600 is provided for directing the operation of computing system 700. Software system 600, which may be stored in system memory (RAM) 706 and on fixed storage (e.g., hard disk or flash memory) 710, includes a kernel or operating system (OS) 610.

The OS 610 manages low-level aspects of computer operation, including managing execution of processes, memory allocation, file input and output (I/O), and device I/O. One or more application programs represented as 602A, 602B, 602C . . . 602N, may be “loaded” (e.g., transferred from fixed storage 710 into memory 706) for execution by the system 600. The applications or other software intended for use on computer system 700 may also be stored as a set of downloadable computer-executable instructions, for example, for downloading and installation from an Internet location (e.g., a Web server, an app store, or another online service).

Software system 600 includes a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 704) of computer system 700. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 700.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 700 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system and may run under the control of other programs being executed on the computer system.

Multiple threads may run within a process. Each thread also comprises an allotment of hardware processing time but share access to the memory allotted to the process. The memory is used to store the content of processors between the allotments when the thread is not running. The term thread may also be used to refer to a computer system process in multiple threads that are not running.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by or within a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers. In a cloud computing environment, there is no insight into the application or the application data. For a disconnection-requiring planned operation, with techniques discussed herein, it is possible to release and then to later rebalance sessions with no disruption to applications.

The above-described basic computer hardware and software and cloud computing environment presented for the purpose of illustrating the basic underlying computer components that may be employed for implementing the example implementation(s). The example implementation(s), however, are not necessarily limited to any particular computing environment or computing device configuration. Instead, the example implementation(s) may be implemented in any type of system architecture or processing environment that one skilled in the art, in light of this disclosure, would understand as capable of supporting the features and functions of the example implementation(s) presented herein.

### Hardware Overview

According to one implementation, the techniques described herein are implemented by one or more special-purpose computing devices. The special-purpose computing devices may be hard-wired to perform the techniques, or may include digital electronic devices such as one or more application-specific integrated circuits (ASICs) or field-programmable gate arrays (FPGAs) that are persistently programmed to perform the techniques, or may include one or more general-purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 7 is a block diagram that illustrates a computer system 700 upon which an implementation of the invention may be implemented. Computer system 700 includes a bus 702 or other communication mechanism for communicating information, and a hardware processor 704 coupled with bus 702 for processing information. Hardware processor 704 may be, for example, a general-purpose microprocessor.

Computer system 700 also includes a main memory 706, such as a random access memory (RAM) or another dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read-only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs Computer System 700 to be a special-purpose machine. According to one implementation, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative implementations, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal, and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic, or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726, in turn, provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710 or other non-volatile storage for later execution.

### Computing Nodes and Clusters

A computing node is a combination of one or more hardware processors that each share access to a byte-addressable memory. Each hardware processor is electronically coupled to registers on the same chip of the hardware processor and is capable of executing an instruction that references a memory address in the addressable memory, and that causes the hardware processor to load data at that memory address into any of the registers. In addition, a hardware processor may have access to its separate exclusive memory that is not accessible to other processors. The one or more hardware processors may be running under the control of the same operating system

A hardware processor may comprise multiple core processors on the same chip, each core processor (“core”) being capable of separately executing a machine code instruction within the same clock cycles as another of the multiple cores. Each core processor may be electronically coupled to connect to a scratchpad memory that cannot be accessed by any other core processor of the multiple core processors.

A cluster comprises computing nodes that each communicate with each other via a network. Each node in a cluster may be coupled to a network card or a network-integrated circuit on the same board of the computing node. Network communication between any two nodes occurs via the network card or network integrated circuit on one of the nodes and a network card or network integrated circuit of another of the nodes. The network may be configured to support remote direct memory access.

In the foregoing specification, implementations of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
receiving, from a large data repository database server at a receiving database server, an object reference data for retrieving particular large data;
based at least in part on the object reference data, determining whether the object reference data references a storage location of the particular large data at the large data repository database server or indicates initiation of data stream of the particular large data from the large data repository database server to receiving database server;
if it is determined that the object reference data indicates the initiation of data stream of the particular large data from the large data repository database server to the receiving database server, without any additional request to the large data repository database server by the receiving database server:
receiving, by the receiving database server, one or more data portions of the particular large data, and
storing the one or more data portions of the particular large data in storage of the receiving database server.

2. The method of claim 1, further comprising:
receiving, at the large data repository database server, a request for the particular large data;
if it is determined that the receiving database server supports receiving the data stream of the particular large data from the large data repository database server without any additional request to the large data repository database server for the particular large data, generating the object reference data that indicates the initiation of the data stream of the particular large data from the large data repository database server to the receiving database server is performed without any additional request to the large data repository database server by the receiving database server;
sending the object reference data to the receiving database server.

3. The method of claim 1, further comprising:
receiving a query at the receiving database server targeting the particular large data stored on the large data repository database server;
requesting the large data repository database server for the object reference data of the particular large data stored on the large data repository database server;
in response to the request for the object reference data of the particular large data stored on the large data repository database server, receiving, at the receiving database server, the object reference data for retrieving the particular large data.

4. The method of claim 1, further comprising:
continuing receiving other portions of the particular large data until all the data portions of the particular large data are received;
storing the particular large data in temporary storage of the receiving database server.

5. The method of claim 1, wherein the particular large data is a large object type (LOB) column, which is stored on the large data repository database server, and the object reference data is an LOB locator to a location of storage of the LOB column.

6. The method of claim 1, further comprising:
if it is determined that the object reference data references the storage location of the particular large data at the large data repository database server:
generating a request, by the receiving database server to the large data repository database server, for the particular large data, wherein the request includes the object reference data;
sending, by the receiving database server, the request to the large data repository database server;
in response to the request to the large data repository database server, receiving, at the receiving database server, the data stream of the particular large data from the large data repository database server.

7. The method of claim 1, wherein the object reference data includes a size of the particular large data, the method further comprising:
comparing the size of the particular large data to buffer memory threshold;
if it is determined that the size of the particular large data exceeds the buffer memory threshold, storing the one or more data portions of the particular large data in a disk storage of the storage of the receiving database server;
if it is determined that the size of the particular large data fails to exceed the buffer memory threshold, storing the one or more data portions of the particular large data in a buffer memory storage of the storage of the receiving database server.

8. The method of claim 1, wherein the object reference data includes character set information of the particular large data, the method further comprising:
based, at least in part, on the character set information of the particular large data as indicated by the object reference data, determining that an original character set of the particular large data is different from a configured character set defined for the particular large data on the receiving database server;
converting the particular large data from the original character set to the configured character set.

9. The method of claim 1, further comprising:
receiving a query, the query indicating an operator to perform an operation on original large data that includes the particular large data of the large data repository database server;
causing the large data repository database server to perform the operation on the original large data, thereby generating a result of the particular large data that is lesser in size than the original large data.

10. The method of claim 1, wherein the particular large data includes extensible markup language (XML) data or JavaScript Object Notation (JSON) data.

11. The method of claim 1, wherein the large data repository database server is a coordinator database server and the receiving database server is a shard database server, the method further comprising:
receiving a query, at the coordinator database server, targeting the particular large data stored at the coordinator database server, based at least in part on a condition to be evaluated on the shard database server during runtime of the query;
generating the object reference data at the coordinator database server and sending the object reference data to the receiving database server;
sending the one or more data portions of the particular large data from the coordinator database server to the shard database server;
storing the particular large data on the shard database server;
executing the query on the shard database server based at least in part on the particular large data stored on the shared database server.

12. One or more non-transitory computer-readable media storing a set of instructions, wherein the set of instructions includes instructions, which when executed by one or more hardware processors, cause:
receiving, from a large data repository database server at a receiving database server, an object reference data for retrieving particular large data;
based at least in part on the object reference data, determining whether the object reference data references a storage location of the particular large data at the large data repository database server or indicates initiation of data stream of the particular large data from the large data repository database server to receiving database server;
if it is determined that the object reference data indicates the initiation of data stream of the particular large data from the large data repository database server to the receiving database server, without any additional request to the large data repository database server by the receiving database server:
receiving, by the receiving database server, one or more data portions of the particular large data, and
storing the one or more data portions of the particular large data in storage of the receiving database server.

13. The one or more non-transitory computer-readable media of claim 12, wherein the set of instructions further includes instructions, which when executed by said one or more hardware processors, cause:
receiving, at the large data repository database server, a request for the particular large data;
if it is determined that the receiving database server supports receiving the data stream of the particular large data from the large data repository database server without any additional request to the large data repository database server for the particular large data, generating the object reference data that indicates the initiation of the data stream of the particular large data from the large data repository database server to the receiving database server is performed without any additional request to the large data repository database server by the receiving database server;
sending the object reference data to the receiving database server.

14. The one or more non-transitory computer-readable media of claim 12, wherein the set of instructions further includes instructions, which when executed by said one or more hardware processors, cause:
receiving a query at the receiving database server targeting the particular large data stored on the large data repository database server;
requesting the large data repository database server for the object reference data of the particular large data stored on the large data repository database server;
in response to the request for the object reference data of the particular large data stored on the large data repository database server, receiving, at the receiving database server, the object reference data for retrieving the particular large data.

15. The one or more non-transitory computer-readable media of claim 12, wherein the particular large data is a large object type (LOB) column, which is stored on the large data repository database server, and the object reference data is an LOB locator to a location of storage of the LOB column.

16. The one or more non-transitory computer-readable media of claim 12, wherein the set of instructions further includes instructions, which when executed by said one or more hardware processors, cause:
if it is determined that the object reference data references the storage location of the particular large data at the large data repository database server:
generating a request, by the receiving database server to the large data repository database server, for the particular large data, wherein the request includes the object reference data;
sending, by the receiving database server, the request to the large data repository database server;
in response to the request to the large data repository database server, receiving, at the receiving database server, the data stream of the particular large data from the large data repository database server.

17. The one or more non-transitory computer-readable media of claim 12, wherein the object reference data includes a size of the particular large data, and wherein the set of instructions further includes instructions, which when executed by said one or more hardware processors, cause:
comparing the size of the particular large data to buffer memory threshold;
if it is determined that the size of the particular large data exceeds the buffer memory threshold, storing the one or more data portions of the particular large data in a disk storage of the storage of the receiving database server;
if it is determined that the size of the particular large data fails to exceed the buffer memory threshold, storing the one or more data portions of the particular large data in a buffer memory storage of the storage of the receiving database server.

18. The one or more non-transitory computer-readable media of claim 12, wherein the set of instructions further includes instructions, which when executed by said one or more hardware processors, cause:
receiving a query, the query indicating an operator to perform an operation on original large data that includes the particular large data of the large data repository database server;
causing the large data repository database server to perform the operation on the original large data, thereby generating a result of the particular large data that is lesser in size than the original large data.

19. The one or more non-transitory computer-readable media of claim 12, wherein the particular large data includes extensible markup language (XML) data or JavaScript Object Notation (JSON) data.

20. The one or more non-transitory computer-readable media of claim 12, wherein the large data repository database server is a coordinator database server and the receiving database server is a shard database server, and wherein the set of instructions further includes instructions, which when executed by said one or more hardware processors, cause:
receiving a query, at the coordinator database server, targeting the particular large data stored at the coordinator database server, based at least in part on a condition to be evaluated on the shard database server during runtime of the query;
generating the object reference data at the coordinator database server and sending the object reference data to the receiving database server;
sending the one or more data portions of the particular large data from the coordinator database server to the shard database server;
storing the particular large data on the shard database server;
executing the query on the shard database server based at least in part on the particular large data stored on the shared database server.
